(19) United States
(12) Patent Application Publication
(10) Pub. No.: US 2014/0136051 A1
(43) Pub. Date: May 15, 2014

(54) INPUT DEVICE FOR A MOTOR VEHICLE

(71) Applicant: GM GLOBAL TECHNOLOGY OPERATIONS LLC, Detroit, MI (US)

(72) Inventors: Michael WAGNER, Rimbach (DE); Stefan POPPE, Darmstadt (DE); Marius WRZESNIEWSKI, Darmstadt (DE); David VOSS, Ruesselsheim (DE); Andreas LANG, Werlgesheim (DE); Marc FUERST, Eisenberg (DE); Joerg HEDRICH, Heidesheim (DE)

(73) Assignee: GM GLOBAL TECHNOLOGY OPERATIONS LLC, Detroit, MI (US)

(21) Appl. No.: 14/081,289

(22) Filed: Nov. 15, 2013

(30) Foreign Application Priority Data
Nov. 15, 2012 (DE) 10 2012 022 362.5

(51) Int. Cl. B60R 16/023

(52) U.S. Cl. CPC B60R 16/0231
USPC 701/36; 701/1; 701/113

(57) ABSTRACT

An input device is provided for a motor vehicle, which comprises a touch-sensitive surface designed to detect the touch of a finger in order to selectively provide one or more instruction types for a connected device, and a finger type recognition unit for recognizing a finger type of the finger detected by the touch-sensitive surface, as well as an instruction output unit for outputting at least one instruction type as a function of the detected finger type.

### CROSS-REFERENCE TO RELATED APPLICATION

This application claims priority to German Patent Application No. 10 2012 022 362.5, filed Nov. 15, 2012, which is incorporated herein by reference in its entirety.

### TECHNICAL FIELD

The technical field relates to an input device for a motor vehicle, for inputting data and/or commands or instructions for a connected device, which is designed for the user-specific provision of one or more instruction types for a connected device.

### BACKGROUND

Given the increasing integration of software systems in motor vehicles, conventional motor vehicles are being increasingly equipped with a plurality of electronic components and functions. Examples for the mentioned components in a motor vehicle include a navigation system, a telephone system or an internet communications system. Examples for the mentioned functions include an air conditioning system in the motor vehicle, a logbook, i.e., a vehicle operating manual in electronic form, as well as a seat adjustment system.

Various input devices are here used to input data and/or a command or an instruction for the electronic components or functions. For example, the input device can exhibit a touch switch for inputting an instruction, which detects the touch of a user to receive instructions. This type of touch switch can also be arranged on a display unit in the form of a touch-sensitive surface. The touch-sensitive surface can here have allocated to it a function depending on the point of contact.

The disadvantage is that when operating the touch-sensitive surface with specific menu buttons or the like that are represented on the display unit, a user must make sure of the position of a corresponding menu button before actually being able to touch it. This in turn causes the user to be distracted, which proves disadvantageous in particular for a driver while operating the motor vehicle, since the driver must keep a very watchful eye on the display unit, so as to determine the respective position of menu buttons. Known from publication DE 10 2006 039 767 A1 is an input device for a motor vehicle, in which a fingerprint is detected by an optical sensor allocated to a touch-sensitive surface, and the fingerprint is used to provide and display a user-specific selection of instruction types for a connected device.

In view of the foregoing, at least one object is to indicate an input device for a motor vehicle that is simple in design, and with which user-specific instruction types can be reliably provided for a connected device. In addition, other objects, desirable features, and characteristics will become apparent from the subsequent summary and detailed description, and the appended claims, taken in conjunction with the accompanying drawings and this background.

### SUMMARY

An input device is provided for a motor vehicle, which encompasses a touch-sensitive surface designed to detect the touch of a finger in order to selectively provide one or more instruction types for a connected device. The input device further encompasses a finger type recognition unit for identifying a user based on a finger type of the finger detected by the touch-sensitive surface, as well as an instruction output unit for outputting at least one instruction type depending on the identified user. Therefore, the underlying idea is to identify a user touching a touch-sensitive surface based on a finger type of the finger detected by the touch-sensitive surface, and selectively output one or more instruction types for a connected device based on this identification.

The advantage to such an input device is that the latter is simple in design, and can be used to reliably provide user-specific instruction types for a connected device. Since the finger type recognition unit is integrated into the touch-sensitive surface, the touch-sensitive surface is designed to ensure not just that the touch of a finger is detected, but also that a finger type of the finger is recognized, for example as a finger sensor, thereby eliminating the need for additional sensors for identifying a user, which in turn results in a simpler and more cost-effective structural design for the input device. In addition, the input device is designed, for example, to preclude the input of an instruction by the user based on finger type recognition, and hence user identification, regardless of the position in which the touch-sensitive surface is contacted. For example, this makes it possible to differentiate between a driver and passenger, and output only those instruction types to the driver of a motor vehicle required for operating the motor vehicle, so that the attention of the driver is not needlessly diverted from vehicle operation. The dimensions of the finger type recognition unit can here correspond to the dimensions of the touch-sensitive surface, or are limited to a portion of the dimensions of the touch-sensitive surface. The finger type can also be recognized if the finger type recognition unit is not directly touched, depending on the configuration of the finger type recognition unit.

The touch-sensitive surface can here involve a touchpad. Such a touchpad can be used to recognize the handwriting, i.e., the touch of a user, and convert it into commands, for example for an infotainment system in the motor vehicle. Such a touchpad can also be used for character recognition, or also to move a cursor on a screen of the infotainment system.

In addition, the finger type recognition unit can be designed as a capacitive sensor. Cost considerations are making these sensors increasingly important as finger sensors, in particular fingerprint sensors. The surface character of an individual fingerprint here serves as the contact, and discharges small capacitor elements differently. The resultant capacity differences are acquired by special electronics, which generate a grayscale pattern of finger lines and grooves. Input devices for a motor vehicle with a touch-sensitive surface are usually also based on capacitive sensors, which replace conventional switches, keys, sliders and control dials. As a consequence, both the function of the touch-sensitive surface and the function of a fingerprint sensor can be implemented by one technology, i.e., with one and the same sensor, thereby eliminating the need for additional costly sensors or systems.

The finger type recognition unit can also be designed as an optical sensor. There are known methods for finger type recognition based on an optical technology, which uses light with one or more wavelengths. It is also possible to base the function of the touch-sensitive surface on optical sensors, so that both the function of the touch-sensitive surface and the function of a fingerprint sensor can again be implemented by one technology, i.e., with one and the same sensor. Further, the function of the finger type recognition unit can also be realized with additional technologies, for example an infrared technology.

In one embodiment, the finger type recognition unit can be designed in such a way as to recognize the finger type of the finger that was detected by the touch-sensitive surface based on recognizing a fingerprint of the finger. Therefore, the input device can detect a fingerprint of a user in order to identify the user who is touching or has touched the touch-sensitive surface, and reliably provide user-specific instruction types for a connected device based on the fingerprint. For example, only those instruction types required for operating the motor vehicle can be displayed to a driver of the motor vehicle, so that the attention of the driver is not needlessly diverted from vehicle operation, while a passenger is given complete access to an infotainment system of the motor vehicle.

In another embodiment, the finger type recognition unit can be designed in such a way as to identify the user who is touching or has touched the touch-sensitive surface by allocating a detected fingerprint to a left or right hand proceeding from the fingers that were detected by the touch-sensitive surface during contact. Therefore, the input device can be designed with the ability to differentiate between a left and right hand in order to identify the user of the input device. For example, a right index finger can be allocated to a driver of the motor vehicle, and a left index finger can be allocated to the passenger, so that user-specific instruction types can be provided accordingly. Further, the finger type recognition unit can be designed to realize the user who is touching or has touched the touch-sensitive surface based on the recognition of a hand shape, proceeding from the fingers that are detected by the touch-sensitive surface.

The input device can further be designed to instruct the output unit to output one or more base functions if the finger type recognition unit recognizes no finger type. This situation is tantamount to the finger type recognition unit not recognizing an authorized user, so that in particular no instruction types for operating the vehicle are to be displayed. For example, the base functions can involve a limited function of the infotainment system in the motor vehicle.

The input device can also encompass a selection device for preselecting at least one instruction type as a function of finger type. This makes it possible to distinguish one finger type for a subsequent use with the input device, i.e., in particular to authorize various users, as a result of which security can be further elevated. In addition, this enables advance settings in which different fingers on one hand are allocated to one instruction type each, regardless of the point of contact. For example, there can be a setting in which a position display is called up through contact with an index finger, and a volume controller by means of a middle finger.

A motor vehicle is also provided that encompasses an input device described above. The advantage to such a motor vehicle is that it encompasses an input device that has a simple design, and with which user-specific instruction types can be reliably provided for a connected device. Since the finger type recognition unit is integrated into the touch-sensitive surface of the input device, the touch-sensitive surface of the input device is designed to ensure not just that the touch of a finger is detected, but also that a finger type of the finger is recognized, for example in the form of a finger sensor, thereby eliminating the need for additional sensors for identifying a user, which in turn results in a simpler and more cost-effective structural design for the input device, and makes it possible to economize on installation space inside the motor vehicle. In addition, the input device is designed in such a way, for example, that the input of an instruction by the user can be precluded based on finger type recognition, and hence user identification, regardless of the position in which the touch-sensitive surface is contacted. For example, this makes it possible to differentiate between a driver and passenger, and output only those instruction types to the driver of a motor vehicle required for operating the motor vehicle, so that the attention of the driver is not needlessly diverted from vehicle operation, which in turn results in an elevated safety during vehicle operation.

The connected device can be a navigation system, an infotainment system of a motor vehicle, an engine start/stop button and/or a vehicle parameter setting device. This make it possible to satisfy the rising demand placed on connected devices, in particular auxiliary equipment in motor vehicles. In addition, motor vehicles are more and more often equipped with infotainment systems, which encompass a plurality of especially wireless devices, and serve to provide entertainment programs and/or information programs for the user of a motor vehicle. For example, information programs can be provided that support the driver of the motor vehicle in a variety of driving situations with callable information or automatically output information and/or automatically execute actions relating to the driving behavior of the motor vehicle, making it possible to enhance driving comfort, while at the same time lowering the risk of accident. However, the connected device can also be any other device connected or integrated in the vehicle, for example a PC. The input device can further be arranged separately from the connected device, or designed as a single piece with the connected device.

A method is also provided for selectively providing one or more instruction types for a connected device for a motor vehicle. The method here encompasses the following steps. Contact by a finger of a user on a touch-sensitive surface of an input device is first detected, and a finger type of the finger detected by the touch-sensitive surface is recognized, after which at least one instruction type is output as a function of the recognized finger type. The finger type is here detected by the touch-sensitive surface during contact. The advantage to such a method is that it can be used to reliably provide user-specific application types for a connected device.

For example, the input of an instruction by the user can be precluded based on finger type recognition, and hence user identification, regardless of the position in which the touch-sensitive surface is contacted. For example, the method makes it possible to differentiate between a driver and passenger, and output only those instruction types to the driver of a motor vehicle required for operating the motor vehicle, so that the attention of the driver is not needlessly diverted from vehicle operation. Also eliminated are other sensors for determining the finger type of the finger that is touching or has touched the touch-sensitive surface, since the finger type is also detected during contact with the touch-sensitive surface, so that both functions can be realized by one technology, making the method easy and cost-effective to implement.

In an embodiment, the step of recognizing a finger type of the finger recognized by the touch-sensitive surface can take place based on detecting a fingerprint of the finger that is touching or has touched the touch-sensitive surface. Therefore, a fingerprint of a user can be detected in order to identify the user who is touching or has touched the touch-sensitive surface. For example, it is possible to differentiate between a driver and passenger of the motor vehicle, and output only those instruction types to a driver of the motor vehicle required for operating the motor vehicle, so that the attention of the driver is not needlessly diverted from vehicle operation, and a passenger is in turn given access to an infotainment system of the motor vehicle.

In another embodiment, the step of recognizing a finger type of the finger detected by the touch-sensitive surface can take place by allocating a detected fingerprint to a left or right hand proceeding from the fingers that were detected by the touch-sensitive surface during contact. This makes it possible to differentiate between a left and right hand, so as to identify the user of the input device. For example, a right index finger can be allocated to a driver of the motor vehicle, and a left index finger can be allocated to the passenger, so that user-specific instruction types can be provided accordingly. In addition, the step of recognizing a finger type of the finger detected by the touch-sensitive surface can be realized based the recognition of a hand shape, proceeding from the fingers that are detected by the touch-sensitive surface.

The method can also comprises the step of recognizing a point of contact on the touch-sensitive surface and providing one or more instruction types based on the recognized finger type and the point of contact. For example, different fingers on a hand can each have allocated to them an instruction type, e.g., the touch of an index finger can start a position controller, and the touch of a middle finger can start a volume controller. This makes it possible to further elevate the reliability of the method.

In addition, the method comprises the step of preselecting at least one instruction type as a function of finger type. As a result, the finger type can be distinguished beforehand for a subsequent use, and recognition can be made reproducible, i.e., in particular various users can be authorized, thereby further enhancing the security of the method.

In summary, let it be noted that the embodiments indicate an input device for a motor vehicle that is simple in design, and with which user-specific instruction types can be reliably provided for a connected device. The input device is characterized by a simple and cost-effective structural design, since the finger type recognition unit is integrated into the touch-sensitive surface, for example in the form of a capacitive sensor, so that the latter is designed to ensure not just that the touch of a finger is detected, but also that a finger type of the finger is recognized, and hence that a user is identified.

The input device can also be used to reliably provide user-specific instruction types for a connected device, for example to preclude the input of an instruction by the user, regardless of the position in which the touch-sensitive surface is contacted, since the input device is designed in such a way that user-specific instruction types can be output based on finger type recognition, and hence on user identification.

### BRIEF DESCRIPTION OF THE DRAWINGS

The present invention will hereinafter be described in conjunction with the following drawing figures, wherein like numerals denote like elements, and:

FIG. 1 shows a block diagram of an input device for a motor vehicle according to an embodiment; and

FIG. 2 shows a flowchart of a method for selectively providing one or more instruction types for a connected device for a motor vehicle according to embodiments.

### DETAILED DESCRIPTION

The following detailed description is merely exemplary in nature and is not intended to limit application and uses. Furthermore, there is no intention to be bound by any theory presented in the preceding background or the following detailed description.

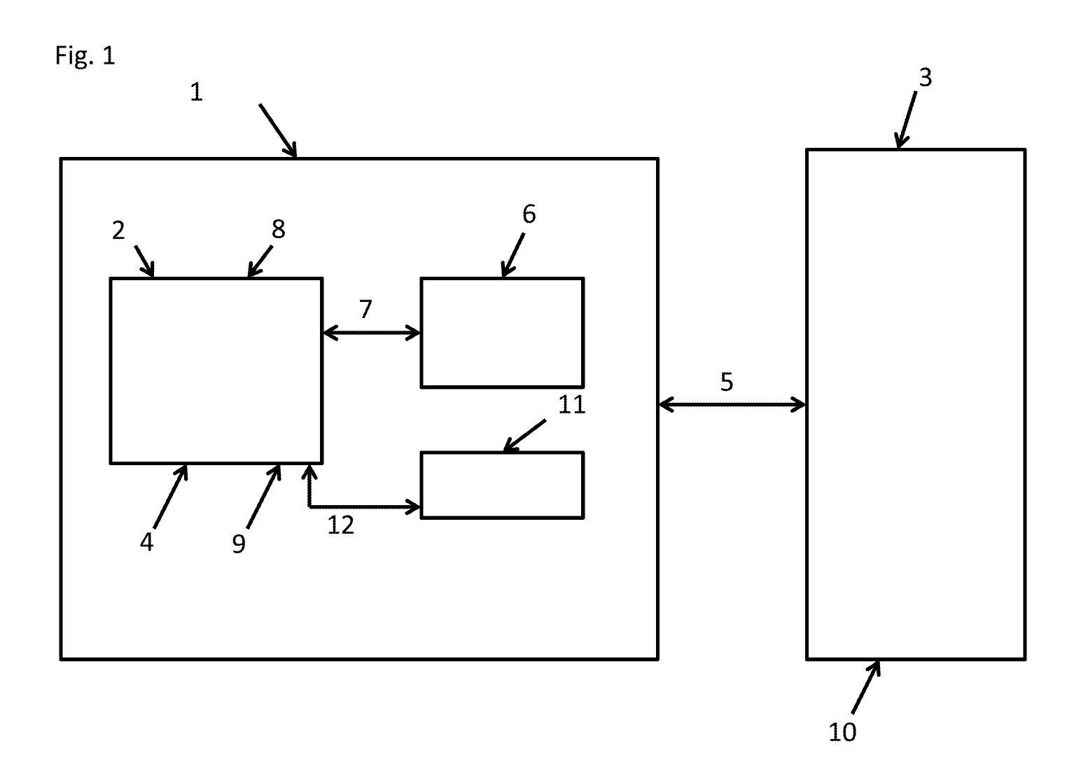

FIG. 1 shows a block diagram of an input device 1 for a motor vehicle according to an embodiment. As shown on FIG. 1, the input device 1 encompasses a touch-sensitive surface 2 designed to detect contact by a finger, so as to thereupon selectively provide one or more instruction types for a connected device 3 coupled with the input device 1, as well as a finger type recognition unit 4 for recognizing a finger type of the finger detected by the touch-sensitive surface. The coupling between the input device 1 and connected device 3 is here symbolized by the arrow provided with reference number 5. In the exemplary embodiment on FIG. 1, the connected device 3 is configured separately from the input device 1. However, the input device can also be designed as a single piece with the input device.

The input device 1 further encompasses an instruction output unit 6 coupled with the touch-sensitive surface 2 for outputting at least one instruction type as a function of the detected finger type. The coupling between the touch-sensitive surface 2 and instruction output unit 6 is here symbolized by the arrow provided with reference number 7. As evident, the finger type recognition unit 4 is here integrated into the touch-sensitive surface 2.

In the exemplary embodiment on FIG. 1, the dimensions of the finger type recognition unit 4 correspond to those of the touch-sensitive surface. However, the finger type recognition unit 4 can also be limited to a portion of the touch-sensitive surface 2, wherein the finger type can also be recognized if the finger type recognition unit 4 is not directly contacted, depending on the configuration of the finger type recognition unit 4. The touch-sensitive surface 2 shown on FIG. 1 here involves a touchpad 8.

The finger type recognition unit 4 is further designed as a capacitive sensor 9. Capacitive sensors are easy and cost-effective to realize. Capacitive sensors can also be used both in touch-sensitive surfaces and as finger sensors, so that the function of the touch-sensitive surface 2 and finger type recognition unit 4 can be realized by a single sensor, thereby eliminating the need for additional sensors, which economizes on installation space and costs.

Further, the finger type recognition unit can also be designed as an optical sensor. It is also possible to realize the function of the finger type recognition unit with other technologies, for example infrared technology. The depicted finger type recognition unit 4 is here designed in such a way as to recognize the finger type of the finger detected by the touch-sensitive surface 2 based on recognizing a fingerprint of the finger. Therefore, the input device is designed to recognize a finger of a user, so as to identify the touching finger and user, and output corresponding user-specific instruction types.

The finger type recognition unit 4 can further also be designed to identify the user who is touching or has touched the touch-sensitive surface by allocating a detected fingerprint to a left or right hand, proceeding from the fingers detected by the touch-sensitive surface 2 during contact. The finger type recognition unit 4 can also be designed to realize the user who is touching or has touched the touch-sensitive surface 2 based on recognizing a hand shape, proceeding from the fingers detected by the touch-sensitive surface 2.

The connected device 3 shown on FIG. 1 involves a navigation system 10 of the motor vehicle. However, the connected device 3 can further also be an infotainment system of the motor vehicle, a start/stop button and/or a vehicle parameter setting device. The finger type recognition unit 4 is additionally designed in such a way as to direct the instruction output unit 6 to output one or more base functions if it recognizes no finger type. For example, the base functions can involve a limited use of an infotainment system in the motor vehicle.

The input device 1 on FIG. 1 further encompasses a selection device 11 coupled with the touch-sensitive surface 2 for preselecting at least one instruction type as a function of a finger type. The coupling between the touch-sensitive surface 2 and selection device is here symbolized by the arrow provided with reference number 12. This makes it possible to distinguish a finger type for subsequent use, i.e., to authorize various users, so that security can be further elevated.

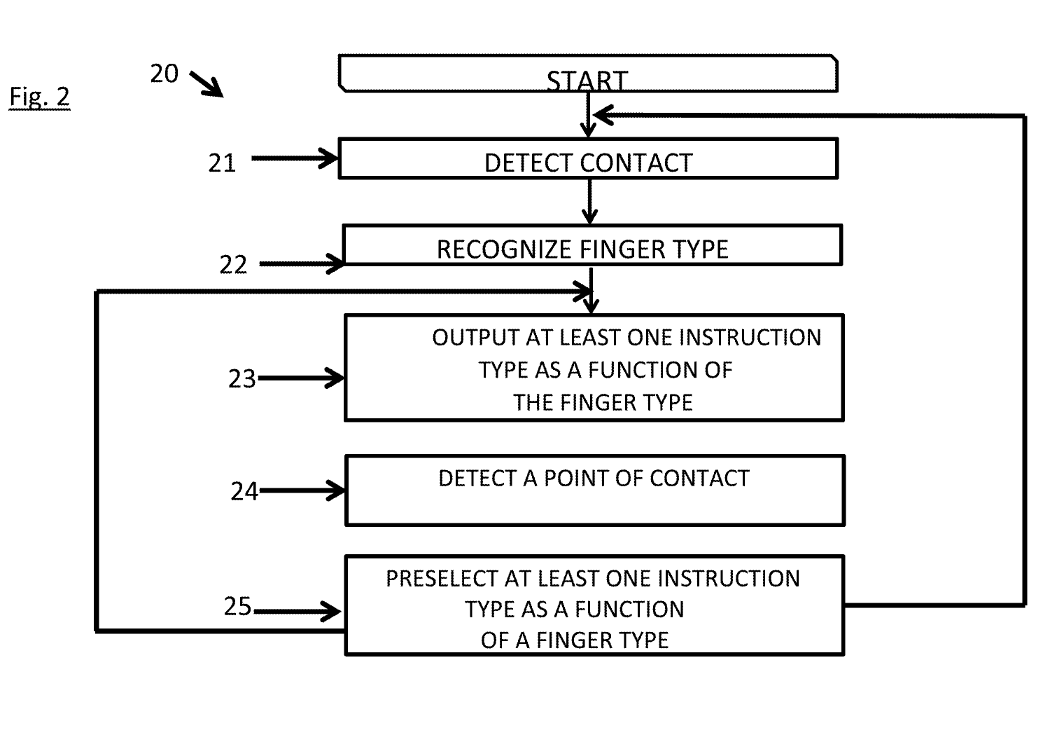

FIG. 2 shows a flowchart of a method 20 for selectively providing one or more instruction types for a connected device for a motor vehicle according to embodiments of the invention. As shown on FIG. 2, the method 20 here encompasses the following steps: Contact by a finger of a user on a touch-sensitive surface of an input device is first detected in step 21. A finger type of the finger detected by the touch-sensitive surface is recognized in another step 22. At least one instruction type is then output as a function of the recognized finger type in step 23. The finger type is here detected by the touch-sensitive surface itself during contact.

Step 22 of recognizing a finger type of the finger detected by the touch-sensitive surface here takes place based on detecting a fingerprint of the finger. As a result, user-specific instruction types can be provided based on the identification of a user by identifying a fingerprint of the user. However, step 22 of recognizing a finger type of the finger detected by the touch-sensitive surface can also be realized by allocating a detected fingerprint to a left or right hand, proceeding from the fingers detected by the touch-sensitive surface 2 during contact, or by recognizing a hand shape, proceeding from the fingers detected by the touch-sensitive surface 2.

As shown on FIG. 2, the method further encompasses the optional step 24 of recognizing a point of contact on the touch-sensitive surface and providing one or more instruction types based on the recognized finger type and point of contact. As a result, a combination of the touching finger, i.e., the finger that does the touching, and the touching position or touched point is associated with at least one specific instruction in order to control a connected device.

The method on FIG. 2 also encompasses step 25 of preselecting at least one instruction type as a function of finger type. This makes it possible to distinguish a finger type beforehand for a later use, i.e., in particular to authorize various users, which further elevates security.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. An input device for a motor vehicle, comprising:
a touch-sensitive surface that is configured to detect a touch of a finger in order to selectively provide an instruction type for a connected device; and
a finger type recognition unit that is configured to recognize a finger type of the finger detected by the touch-sensitive surface; and
an instruction output unit that is configured to output the instruction type as a function of the finger type.

2. The input device according to claim 1, wherein the touch-sensitive surface is a touchpad.

3. The input device according to claim 1, wherein the finger type recognition unit is a capacitive sensor.

4. The input device according to claim 1, wherein the finger type recognition unit is an optical sensor.

5. The input device according to claim 1, wherein the finger type recognition unit is configured to recognize the finger type of the finger that was detected by the touch-sensitive surface based on recognizing a fingerprint of the finger.

6. The input device according to claim 1, wherein the finger type recognition unit is configured to identify by allocating a detected fingerprint to a left hand proceeding from the fingers detected by the touch-sensitive surface during contact.

7. The input device according to claim 1, wherein the finger type recognition unit is configured such a way that the finger type recognition unit is configured to instruct the instruction output unit to output a base function if the finger type is unrecognizable.

8. The input device according to claim 1, wherein the input device comprises a selection device for preselecting at least one instruction type as a function of finger type.

9. (canceled)

10. The input device according to claim 1, wherein the connected device is a navigation system.

11. A method for selectively providing an instruction type for a connected device for a motor vehicle, comprising:
detecting contact by a finger of a user with a touch-sensitive surface of an input device;
recognizing a finger type of the finger touching the touch-sensitive surface with a finger type recognition unit, wherein the finger type is detected by the touch-sensitive surface; and
outputting the instruction type as a function of the finger type.

12. The method according to claim 11, wherein the step of recognizing the finger type of the finger touching the touch-sensitive surface is based at least in part on recognizing a fingerprint of the finger.

13. The method according to claim 11, wherein the step of recognizing the finger type of the finger touching the touch-sensitive surface comprises allocating a detected fingerprint to a left hand proceeding from the finger detected by the touch-sensitive surface during contact.

14. The method according to claim 11, wherein the method further comprises:
recognizing a point of contact on the touch-sensitive surface; and
providing an instruction type based on the finger type and the point of contact.

15. The method according to claim 11, wherein the method further comprises preselecting at least one instruction type as a function of finger type.

16. The input device according to claim 10, wherein the connected device is an infotainment system of the motor vehicle.

17. The input device according to claim 10, wherein the connected device is an engine start button.
